(19) United States
(12) Patent Application Publication
(10) Pub. No.: US 2025/0246968 A1
(43) Pub. Date: Jul. 31, 2025

(54) COUNTER-ROTATING DIFFERENTIAL ELECTRIC MOTOR ASSEMBLY SLIP RING ASSEMBLY

(71) Applicant: CR FLIGHT L.L.C., Carmichael, CA (US)

(72) Inventors: Randell J. Wishart, Reno, NV (US); Jonathan D. Emigh, Somerset, CA (US); Jason Emigh, Somerset, CA (US); Ray Porter, La Verkin, UT (US)

(73) Assignee: CR FLIGHT L.L.C., Carmichael, CA (US)

(21) Appl. No.: 19/047,407

(22) Filed: Feb. 6, 2025

Related U.S. Application Data
(62) Division of application No. 17/677,576, filed on Feb. 22, 2022.
Application No. 17/677,576 is a continuation of application No. PCT/US2020/047837, filed on Aug. 25, 2020.
(60) Provisional application No. 62/993,594, filed on Mar. 23, 2020.
(60) Provisional application No. 62/893,293, filed on Aug. 29, 2019.
(60) Provisional application No. 62/893,290, filed on Aug. 29, 2019.

(51) Int. Cl. H02K 5/24; B64C 11/48; B64D 27/24; H02K 1/2791; H02K 7/00; H02K 7/14; H02K 13/00; H02K 21/24; H02K 23/60

(52) U.S. Cl. CPC H02K 5/24; B64D 27/24; H02K 1/2791; H02K 7/003; H02K 7/14; H02K 13/003; H02K 21/24; H02K 23/60; B64C 11/48

(57) ABSTRACT

A rotational slip ring assembly for an improved counter-rotating (CR) differential electric motor assembly is utilized to power an aircraft vehicle or fan for moving a gas and includes two oppositely rotating propellers that may be mounted to horizontal flight and vertical lift-off aircraft or a fan housing in spaces similar in size to mounting spaces for traditional motors having only one propeller and includes a hollow central shaft and slip ring assembly that is mounted either within, slight above, or total above oppositely rotating components and around the hollow central shaft.

### CROSS-REFERENCE TO RELATED APPLICATIONS

This application is a division of U.S. patent application Ser. No. 17/677,576 filed on Feb. 22, 2022, incorporated herein by reference in its entirety, which claims priority to, and is a 35 U.S.C. § 111(a) continuation of, PCT international application number PCT/US2020/047837 filed on Aug. 25, 2020, incorporated herein by reference in its entirety, which claims priority to, and the benefit of, (i) U.S. provisional patent application Ser. No. 62/893,293 filed on Aug. 29, 2019, incorporated herein by reference in its entirety, (ii) U.S. provisional patent application Ser. No. 62/993,594 filed on Mar. 23, 2020, incorporated herein by reference in its entirety, and (iii) U.S. provisional patent application Ser. 62/893,290 filed on Aug. 29, 2019, incorporated herein by reference in its entirety. Priority is claimed to each of the foregoing applications.

The above-referenced PCT international application was published as PCT International Publication No. WO 2021/041435 A1 on Mar. 4, 2021, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to a counter-rotating (CR) differential electric motor assembly, normally of medium to large size (10 to >100 lbs. of thrust) and frequently utilized for powering an aircraft or for air-movement/fan technologies. More specifically, the subject invention is a CR differential electric motor assembly that is often employed to power horizontal flight and vertical take-off and landing (VTOL) aircraft and permits two associated/linked propellers to rotate very close to one another about a common central axis, wherein the airflow generated by one propeller is differentially coupled into the rotation of the other propeller, thereby increasing the efficiency of power consumption by the CR motor over an equivalent standard/traditional motor that rotates a single propeller. The subject invention may be employed with aircraft or fan housings in spaces that were originally configured for standard/traditional motors.

### 2. Background Discussion

U.S. Pat. Nos. 8,198,773; 8,253,294; and 8,531,072 (issued to the subject Applicant) are for various counter-rotating motor/generator applications.

Of relevance is U.S. Pat. No. 10,116,187 (issued to the subject Applicant and referred to as patent '187) for a Thin-Profile Counter-Rotating Differential Electric Motor Assembly. In particular, this CR motor assembly is specifically for relatively small electric motors, usually less than about 10 lbs. of thrust. As is described in patent '187, the CR motor assembly comprises: central solid shaft (either fixed or rotating) having first and second ends; first and second rotational members that rotate in opposite directions about said central solid shaft; first and second propellers secured to the first and second rotational members, respectfully; electromagnetic means to power the rotation associated with the first and second rotational members; and means for conveying electricity into the electromagnetic means from an outside power source that is located between the oppositely rotating rotational members and a mounting means and is secured to the central solid shaft second end. This specific design is ideal for small CR motors in which the mass of the CR motor (mostly the first and second rotational members and electromagnetic means) is relatively small (about <10 lbs. of thrust). However, with medium to large CR motors (about 10 to >100 lbs. of thrust) the mass of the first and second rotational members and electromagnetic means becomes significant and to prevent deleterious rotation-created harmonics is the central shaft during operation the first and second rotational members and electromagnetic means need to be as close to the mounting means (base plate) as possible. The CR motor disclosed in patent '187 positions the electricity conveyance means (usually a slip ring assembly or the equivalent) between the first and second rotational members and electromagnetic means and the mounting means thereby placing the first and second rotational members and electromagnetic means at quite a distance from the mounting means. Again, this is perfectly fine for small CR motors, but for CR motors of increased size harmful resonances are easily generated.

In addition, International Publication WO 2018/106611 (also issued to the subject Applicant and referred to as WIPO '611) describes an electricity conveyance means or High Current and RPM-Capable Slip Ring Assembly that can be utilized with the CR motors disclosed in patent '187. However, as with the patent '187 CR motor, this slip ring assembly must be utilized between the first and second rotational member (and associated electromagnetic means) and the mounting means since the electrical wires run from the power source to the outside of the slip ring assemble. The central shaft or axel is solid for this slip ring assemble. To position this slip ring assembly within or above the first and second rotational members (to bring the mass of the first and second rotational member and electromagnetic means closed to the mounting means) is impossible due to the oppositely rotating propellers tangling with the electrical wires.

### BRIEF SUMMARY

An object of the technology described herein is to provide a medium to large CR differential electric motor assembly that is utilized to power horizontal flight and vertical take-off and landing aircraft.

An additional object of the technology described herein is to provide a medium to large CR differential electric motor assembly that is utilized to power a fan for the movement of air or other gases.

Another object of the technology described herein is to furnish a medium to large CR differential electric motor assembly, with two propellers, that is utilized to power horizontal flight and vertical take-off and landing aircraft that requires approximately the same space allocation as a traditional/standard motor, with one propeller, does in the aircraft.

A further object of the technology described herein is to supply a medium to large CR differential electric motor assembly that is utilized to power horizontal flight and vertical take-off and landing aircraft with decreased electrical power input relative to mechanical power output when compared with a standard/traditional motor having a single propeller.

Still another object of the technology described herein is to disclose a medium to large CR differential electric motor assembly that is utilized to power horizontal flight and vertical take-off and landing aircraft with increased battery life and more thrust that an equivalent standard/traditional motor.

Still an additional object of the subject invention is to disclose a medium to large CR motor that utilizes a combination of 1) added energy not wasted to a traditional motor mount, 2) added energy due to lower heat production, 3) added energy due to reduced vibrational harmonics created by middle to outer positioning of its slip ring assembly, and 4) synergistic differential coupling between the two oppositely rotating members to increase their net rotational velocities to increase the efficiency of the CR motor over a standard motor.

Disclosed is a medium to large CR differential electric motor assembly utilized to power an aircraft vehicle or fan that comprises: a) a central hollow shaft (or axel) having a first and second ends; b) two oppositely rotating rotational members mounted about the central hollow shaft, wherein a first rotating member includes field coil windings and a second rotating member includes permanent magnets; c) a first set of propeller blades secured to the first rotational member and a second set of propeller blades secured to the second rotational member; d) a slip ring assembly for carrying electricity to the field coils from an electric power supply and controller that is located either around the central hollow shaft and within the first and second rotational members or totally or partially above (towards the first end) of the central hollow shaft; e) a mounting base for securing the CR motor assembly to the vehicle or fan; f) optionally, the control means for operating the CR motor assembly; g) and optionally, the electric power supply.

Additionally, disclosed is a rotational slip ring assembly for transmitting electricity from a first location to a second location, comprising: at least one pair of electrically conductive disks with each disk having a central aperture that comprise: a first disk having an inner aperture edge and an outer perimeter edge and a second disk having an inner aperture edge and an outer perimeter edge; a first location electrical connection attached to the first disk's inner aperture edge; a second location electrical connection attached to the second disk's outer perimeter edge; and a spindle housing surrounding the pair of electrically conductive disks, wherein the spindle housing permits the pair of electrically conductive disks to rotate on one another.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A is a side view of an embodiment of the subject invention in which the slip ring assembly is located either partially or totally above the first and second rotational members and around the central hollow shaft.

FIG. 1B is a transparent view of the embodiment seen in FIG. 1A.

FIG. 1C is a cross-sectional view of the embodiment seen in FIG. 1A.

FIG. 2A is a side view of another embodiment of the subject invention in which the slip ring assembly is located within the first and second rotational members and around the central hollow shaft.

FIG. 2B is a transparent view of the embodiment seen in FIG. 2A.

FIG. 2C is a cross-sectional view of the embodiment seen in FIG. 2A.

FIG. 3 is a cross-sectional view of the slip ring assembly utilized in FIGS. 1A, 1B, and 1C.

FIG. 4 is cross-sectional view of the slip ring assembly utilized in FIGS. 2A, 2B, and 2C.

FIG. 5 is a top partially transparent view of another embodiment of the subject invention showing equally spaced slip ring assembly to field coil connections and wires.

FIG. 6 is an alternative embodiment showing three electrical contact groups within the subject slip ring assembly.

FIG. 7 shows the components of a single electrical contact group with the alternative embodiment of the subject slip ring assembly.

FIG. 8 shows a close up of the alternative embodiment of the slip ring assembly.

FIG. 9 shows the alternative embodiment of the slip ring assembly associated with the CR motor components.

### DETAILED DESCRIPTION

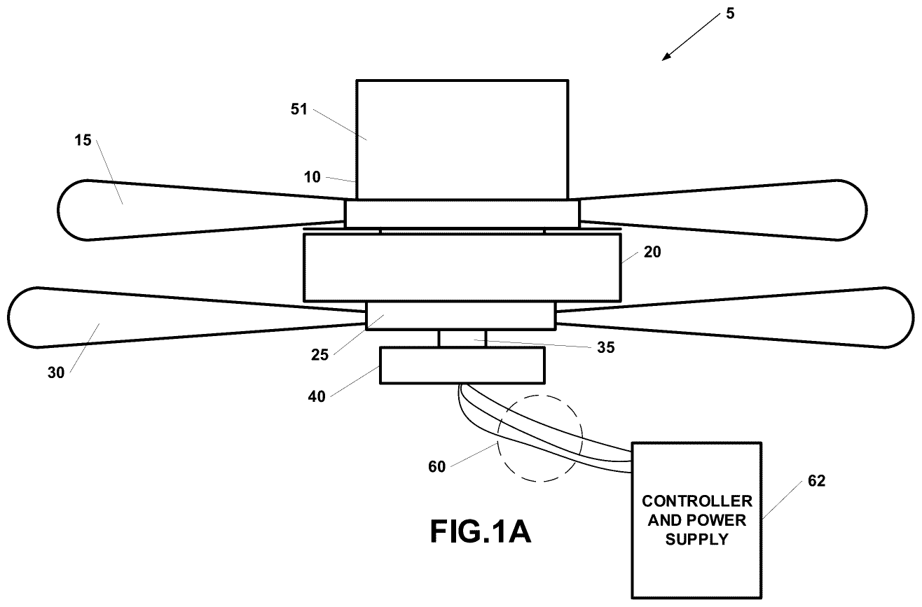

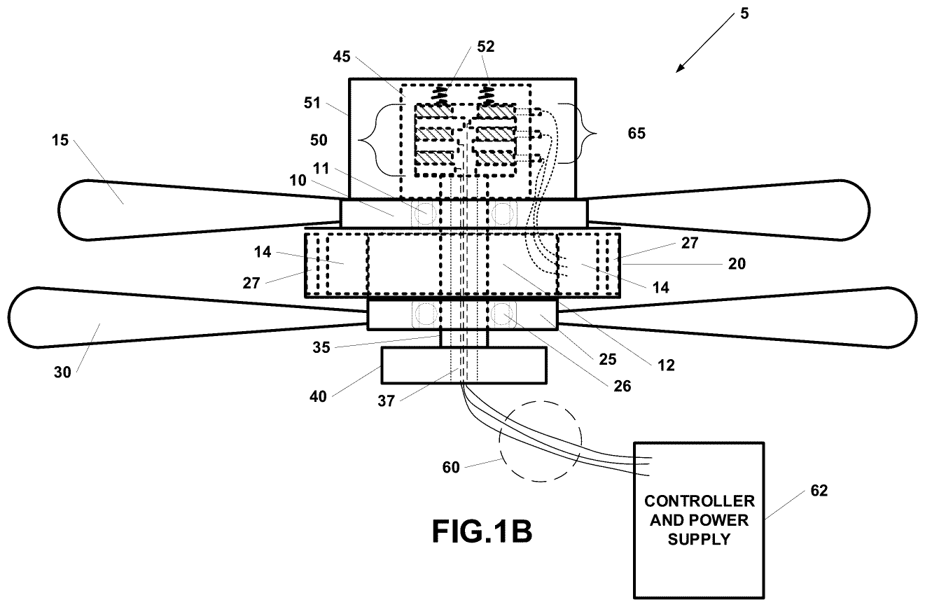

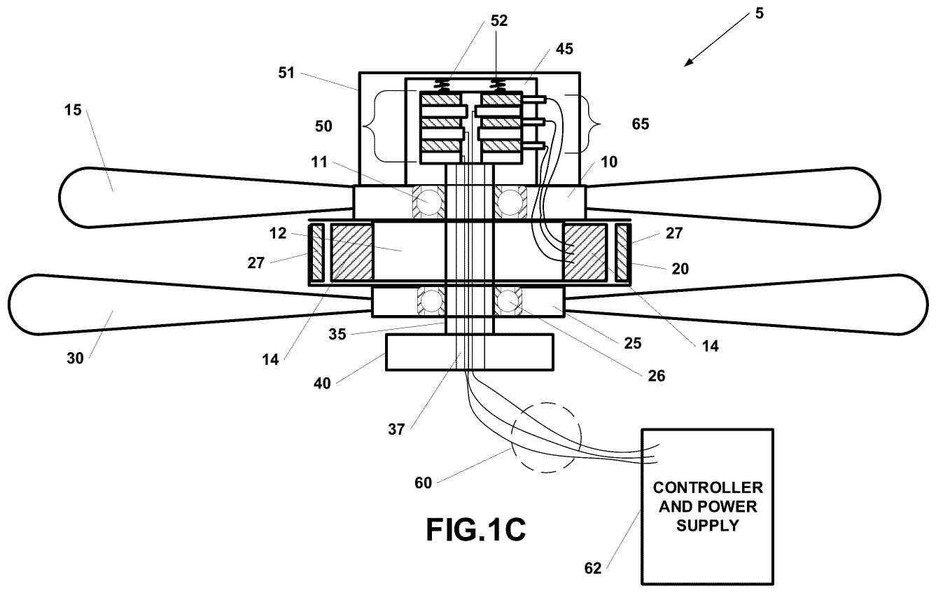

Referring more specifically to the drawings, for illustrative purposes the subject technology is embodied in the system generally shown in FIGS. 1 through 9. It will be appreciated that the subject system CR differential electric motor assembly may vary as to configuration and as to details of the components, and that the method may vary as to the specific steps and sequence of operation, without departing from the basic concepts as disclosed herein.

The subject small to large CR motor may be of any desired electrical phase configuration, however, for exemplary purposes only and not by way of limitation, the CR motor related herein is a brushless electrical three-phase design. Other phase designs function equally as well as the current three-phase version. A suitable controller and power supply are employed to operate the subject CR motor.

Generally, the subject invention is a medium (about >10 lbs. thrust) to large (about >100 lbs. thrust) CR differential electric motor assembly utilized to power an aircraft vehicle or a fan for moving a gas. With a CR motor (or any medium to large motor) that has significant mass associated with its components, positioning the rotational components motor closer to the mounting base helps eliminate harmful rotational vibrations that reduce thrust, waste energy, wear bearings, and create deleterious heat. The subject CR motor comprises: a) a central hollow shaft having outer (first) and inner (second, in the mounting base region) ends and oriented along a central axis that provides structural support for the CR differential electric motor assembly; b) an inner (first) rotational member secured to electromagnetic field coils around its outer perimeter, wherein the inner rotational member rotates, during operation, in a first direction about the central axis; c) a first bearing assembly secured to the inner rotational member that permits the inner rotational member to rotate in the first direction about the central axis; d) an outer rotational member that rotates, during operation, about the central axis in an opposite second direction to the first rotational member; wherein the outer rotational member is lined with a plurality of permanent magnets that are repelled by the electromagnetic field coils, when energized; e) a second bearing assembly secured to the outer rotational member that permits the outer rotational member to rotate in the second direction opposite to the first rotational direction about the central axis; f) a first propeller assembly secured to the inner rotational member, wherein the first propeller assembly comprises at least two propeller blades; g) a second propeller assembly secured to the second rotational member, wherein the second propeller assembly comprises at least two propeller blades; h) a mounting base member secured to the second end of the central hollow shaft; and h) a slip ring assembly for carrying electricity to the field coil windings from an outside controller and power supply, wherein the slip ring assembly is positioned either within the first and second rotational members about the central hollow shaft or slightly projecting above or totally above the first and second rotational members about the central hollow shaft.

It is stressed that the following description relates specifically to horizontal flight and VTOL aircraft for exemplary purposes only and not by way of limitation and that the subject CR motor invention is also employed for air moving devices such as fans in homes or commercial buildings.

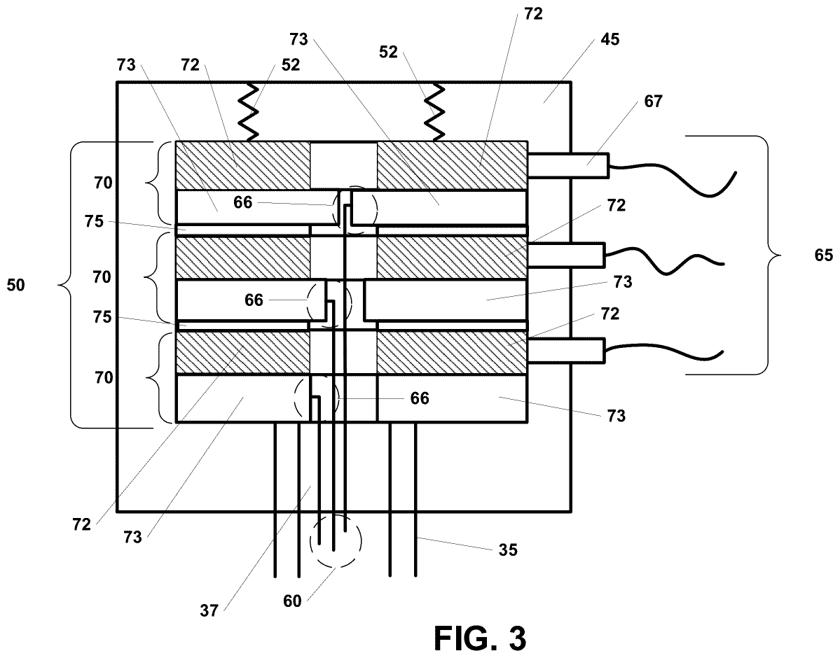

More specifically, as shown in FIGS. 1A, 1B, 1C, and 3 a first embodiment of the subject invention 5 is shown in which a slip ring assembly is positioned above the two oppositely rotating rotational members. Generally, this embodiment includes a first rotational member that comprises both an outer portion 10 and inner portion 12 that are rotational secured by bearings 11 to a central hollow shaft 35. For clarity, “outer” refers to further away on the central hollow shaft 35 from a mounting base member 40 and “inner” refers to nearer the mounting base member 40. A propeller 15 is fastened to the outer portion 10. The illustrative propeller 15 comprises two blades, but other blade numbers (two, four, etc.) are contemplated to be within the realm of this disclosure. Electromagnetic field coils 14 are secured to the inner portion 12 of the first rotational member.

A second rotational member comprises both an outer portion 20 and an inner portion 25 that are rotational secured by bearings 26 to the central hollow shaft 35. A propeller 30 is fastened to the inner portion 25. Again, the illustrative propeller 30 comprises two blades, but other blade numbers (two, four, etc.) are contemplated to be within the realm of this disclosure. Permanent magnets 27 are secured to and line the inside perimeter of the outer portion 20 of the second rotational member.

The central hollow shaft 35 is secured to a mounting base 40 and does not rotate during operation of the CR motor. The mounting base may be utilized to secure the subject CR motor to devises such as air vehicles and air moving systems. The central hollow shaft 35 is hollow to permit electrical wiring 60 to pass through it from the exterior controller and power supply 62 to the electricity receiving components of the slip ring assembly (sintered/porous disks 73 as seen in FIG. 3). The wiring 60 attaches at location 66. The central hollow shaft 35 is usually fabricated from a suitable metal or metal alloy, however, structurally acceptable polymers may be employed and has an interior passage 37 through which the wires 60 are positioned. It is stressed that the interior passage 37 is normally round, however, variously cut channels in the central shaft 35 are possible, but the round passage is preferred to prevent harmful rotational resonances.

Since each CR motor has two oppositely rotating members with one having a set of permanent magnets 27 (second rotational member outer portion 20) and the other having field coil windings 14 (first rotational member inner member 12), a non-traditional means is required to deliver electricity to those field coil windings 14. The preferred electricity transfer means for embodiment 5 is a slip ring assembly that can be seen in FIGS. 1B, 1C, and 3. Comprising the slip ring assembly is a set of paired electrically conducting disks 50 that are fabricated from lubricant-containing sintered/porous metals or metal allows (one such readily commercially available sintered/porous material is termed Oilite™). Bronze, brass, steel, and the like are often utilized to produce the sintered/porous disks. The sintered/porous disks contain microscopic passageways which trap an applied lubricant within and slowly release the lubricant during operation. The lubricant may be natural and synthetic oils, with lighter SAE 10-50 preferred, but other viscosities are found to be within the realm of this disclosure.

Normally, it is preferred that both disks in the pairs 70 are lubricated sintered/porous disks, however, it is noted that only one member of each paired set of disks 70 may be sintered/porous and the other a non-sintered/porous material such as a metal or metal alloy, however, it was found that this possibility has much higher wear characteristics during operation of the CR motor. Sintered/porous disks on sintered/porous disks, both lubricated, were found to have extremely low wear characteristics during long term operation (>100 hours) of the CR motors.

The set of paired disks shown in FIGS. 1B, 1C, and 3 comprise three pairings 70 with an outer 72 and inner 73 disk in each set. Each disk 70 and 72 have an inner aperture edge and an outer perimeter edge. Each incoming electrical connection requires one paired set 70 with outer 72 and inner 73 disks. Thus, the exemplary CR motor 5 utilizes three phase wiring so three wires 60 enter from the controller and power supply 62 into the central hollow shaft opening 37 and continue to the set of three paired disks 50. In each set 70, the inner disk 73 in is held stationary in a spindle housing 45 while the CR motor is operational. Therefore, each of the three incoming wires 60 are secured to one of the stationary inner disks 73 at an inner aperture edge. Each pair of disks 70 (outer 72 and inner 73) are electrically isolated from the next pair of disks 70 by an insulator disk 75. The outer disks 72 in each paired set is connected, via an attached tab 67 that locks the outer disks 72 into the spindle housing 45, to an exiting wire 65 that runs to the field coils 14. It is noted that for each set of disks 70 the entering and exiting wires may be switched, as long as one disk in each pair is stationary and one disk is rotational and as long as the entering wires are attached to stationary disks and the exiting wires are secured to the rotational disks. The set of three paired disks 50 are held within a spindle housing 45 that includes resilient means of one or more springs 52 that apply compression to the stacked set of disks for maintaining electrical contact during CR motor operation. The spindle housing 45 is fabricated from non-electrically conductive polymers that are sufficiently rigid such as Delrin, PEEK, various nylons, and like materials. The spindle housing 45 and associated components are usually, but not necessarily, surrounded by slip ring assembly cover 51.

It is stressed that, if desired, the outer disks 72 may be the non-rotational disks attached to the incoming wires 60 and the inner disks 73 may be the rotational disks attached to the outgoing/exiting wires 65.

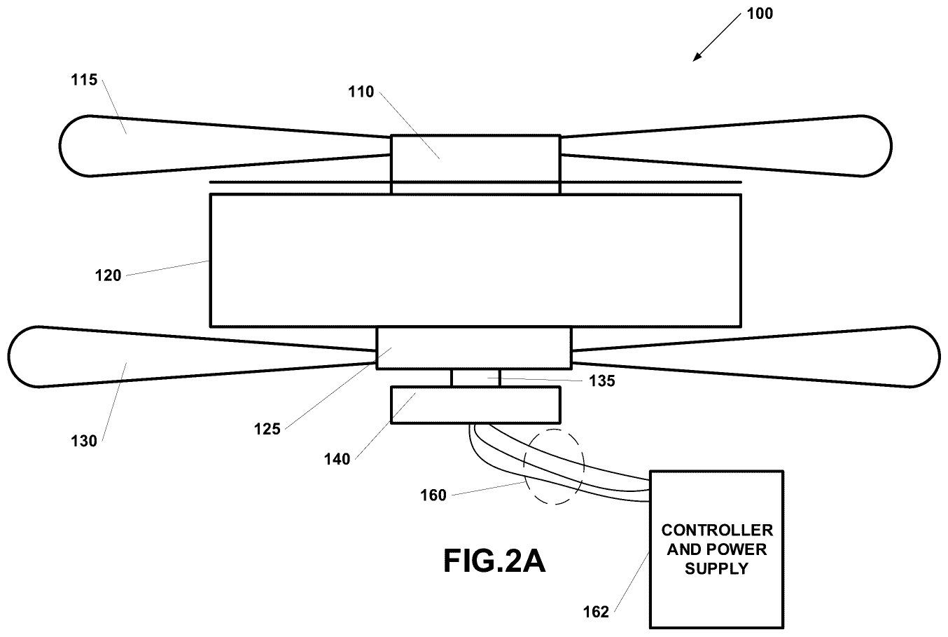

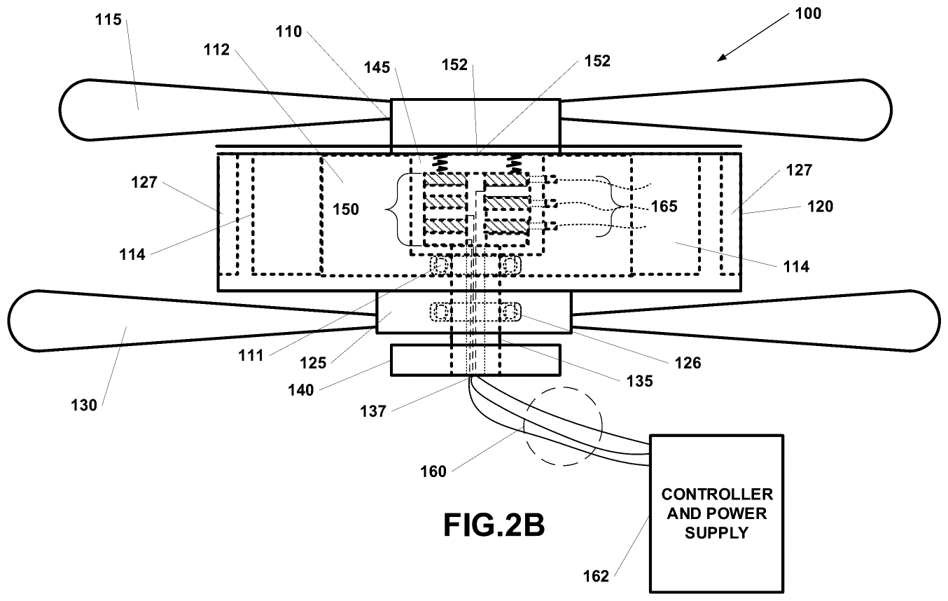

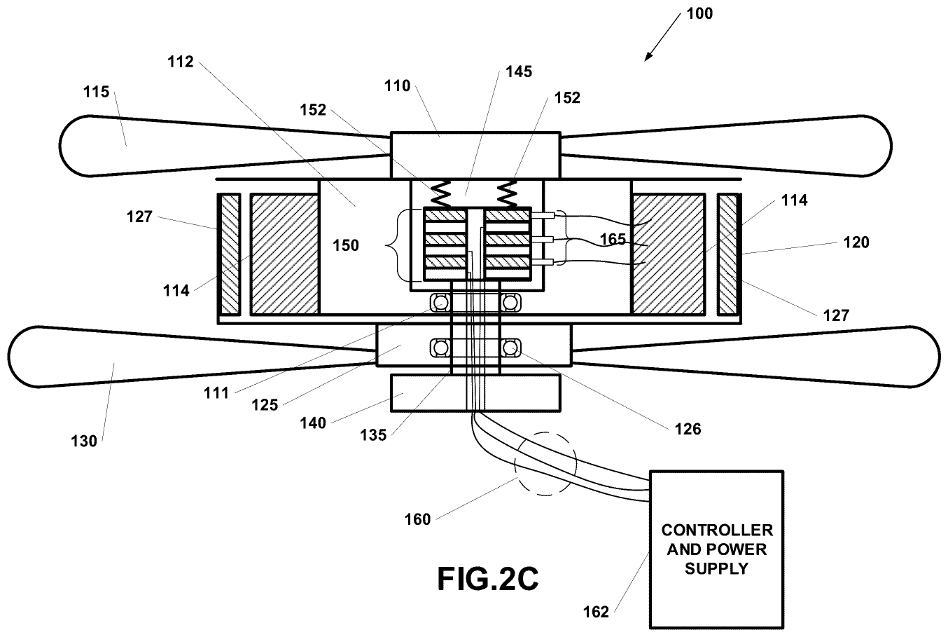

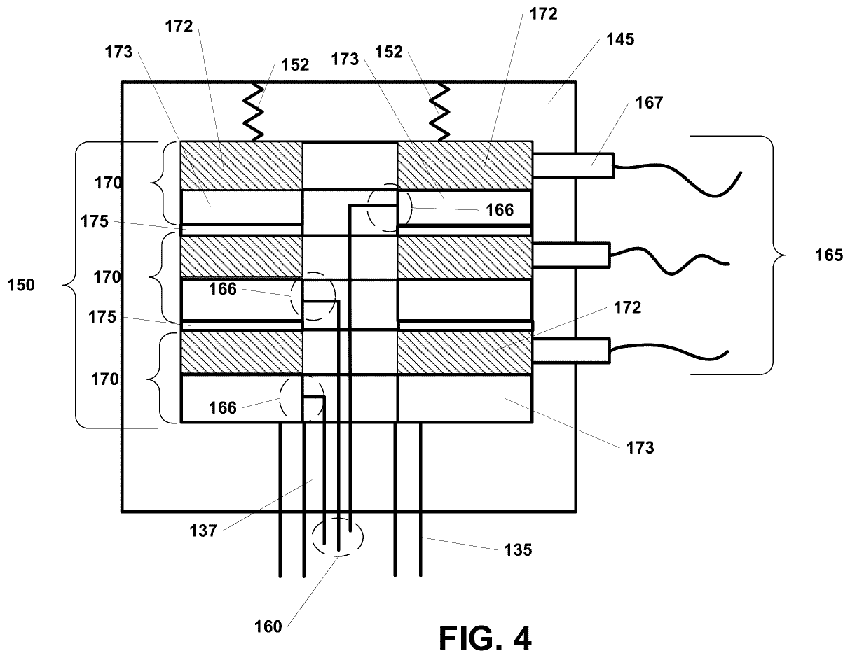

A second embodiment of the subject invention is shown in FIGS. 2A, 2B, 2C, and 4 and includes, generally, a dual propeller CR differential electric motor assembly; comprising: a central hollow shaft having first and second ends; a first rotational member, located about said central hollow shaft, that rotates in a first direction about said central hollow shaft; a first propeller secured to said first rotational member; a second rotational member, located about said central hollow shaft and either within said first and second rotational members or between said first rotational member and said second end of said central hollow shaft, that rotates in an opposite direction to said first rotational member's rotational direction and about said central hollow shaft; a second propeller secured to said second rotational member; electromagnetic field coils and permanent magnets associated with said first and second rotational members for powering, when receiving electricity via wires traveling from an exterior power source through said central hollow shaft, said rotation of said first and second rotational members in opposite directions about said central hollow shaft; a slip ring assembly for transmitting electricity from an exterior power source to said electromagnetic means, wherein said slip ring assembly is located about said central hollow shaft between said first rotational member and said first end of said central hollow shaft; and a base member for mounting said oppositely rotating first and second rotational members, said slip ring assembly, and said central hollow shaft to a supporting structure, wherein said base member is located proximate said second end of said central hollow shaft.

More specifically, FIGS. 2A, 2B, 2C, and 4 relate a second embodiment of the subject invention 100 in which a slip ring assembly is positioned between or slightly above the two oppositely rotating rotational members. For FIGS. 2A, 2B, 2C, and 4 the element indicia are in the 100s and are equivalent to those seen in FIGS. 1A, 1B, 1C, and 3 with the first embodiment, however, the slip ring assembly is lowered into the space within the two oppositely rotating members. Generally, this embodiment includes a first rotational member that comprises both an outer portion 110 and inner portion 112 that are rotational secured by bearings 111 to a central hollow shaft 135. For clarity, “outer” refers to further away on the central hollow shaft 135 from a mounting base member 140 and “inner” refers to nearer the mounting base member 140. A propeller 115 is fastened to the outer portion 110. The illustrative propeller 115 comprises two blades, but other blade numbers (two, four, etc.) are contemplated to be within the realm of this disclosure. Electromagnetic field coils 114 are secured to the inner portion 112 of the first rotational member.

A second rotational member comprises both an outer portion 120 and an inner portion 125 that are rotational secured by bearings 126 to the central hollow shaft 135. A propeller 130 is fastened to the inner portion 125. Again, the illustrative propeller 130 comprises two blades, but other blade numbers (two, four, etc.) are contemplated to be within the realm of this disclosure. Permanent magnets 127 are secured to and line the inside perimeter of the outer portion 120 of the second rotational member.

The central hollow shaft 135 is secured to a mounting base 140 and does not rotate during operation of the CR motor. The mounting base 140 may be utilized to secure the subject CR motor to devises such as air vehicles and air moving systems. The central hollow shaft 135 is hollow to permit electrical wiring 160 to pass through it from the exterior controller and power supply 162 to the electricity receiving components of the slip ring assembly (sintered/porous disks 173 as seen in FIG. 4). The wiring 160 attaches at location 166. The central hollow shaft 135 is usually fabricated from a suitable metal or metal alloy, however, structurally acceptable polymers may be employed and has an interior passage 137 through which the wires 160 are positioned. It is stressed that the interior passage 137 is normally round, however, variously cut channels in the central shaft 135 are possible, but the round passage is preferred to prevent harmful rotational resonances.

Since each CR motor has two oppositely rotating members with one having a set of permanent magnets 127 (second rotational member outer portion 120) and the other having field coil windings 14 (first rotational member inner member 112), a non-traditional means is required to deliver electricity to those field coil windings 114. The preferred electricity transfer means for embodiment 100 is a slip ring assembly that can be seen in FIGS. 2B, 2C, and 4. Comprising the slip ring assembly is a is a set of paired electrically conducting disks 150 that are fabricated from lubricant-containing sintered/porous metals or metal allows (one such readily commercially available sintered/porous material is termed Oilite™). Bronze, brass, steel, and the like are often utilized to produce the sintered/porous disks. The sintered/porous disks contain microscopic passageways which trap an applied lubricant within and slowly release the lubricant during operation. The lubricant may be natural and synthetic oils, with lighter SAE 10-50 preferred, but other viscosities are found to be within the realm of this disclosure.

Normally, it is preferred that both disks in the pairs 170 are lubricated sintered/porous disks, however, it is noted that only one member of each paired set of disks 170 may be sintered/porous and the other a non-sintered/porous material such as a metal or metal alloy, however, it was found that this possibility has much higher wear characteristics during operation of the CR motor. Sintered/porous disks on sintered/porous disks, both lubricated, were found to have extremely low wear characteristics during long term operation (>100 hours) of the CR motors.

The set of paired disks shown in FIGS. 2B, 2C, and 4 comprise three pairings 170 with an outer 172 and inner 173 disk in each set. Each disk 172 and 173 have an inner aperture edge and an outer perimeter edge. Each incoming electrical connection requires one paired set 170 with outer 172 and inner 173 disks. Thus, the exemplary CR motor 100 utilizes three phase wiring so three wires 160 enter from the controller and power supply 162 into the central hollow shaft opening 137 and continue to the set of three paired disks 150. It is noted that for each set of disks 170 the entering and exiting wires may be switched, as long as one disk in each pair is stationary and one disk is rotational and as long as the entering wires are attached to stationary disks and the exiting wires are secured to the rotational disks. In each set 170, the inner disk 173 in is held stationary in a spindle housing 145 while the CR motor is operational. Therefore, each of the three incoming wires 160 are secured to one of the stationary inner disks 173. Each pair of disks 170 (outer 172 and inner 173) are electrically isolated from the next pair of disks 170 by an insulator disk 175. The outer disks 172 in each paired set is connected, via an attached tab 167 that locks the outer disks 172 into the spindle housing 145, to an exiting wire 165 that runs to the field coils 114. The set of three paired disks 150 are held within the spindle housing 145 that includes resilient means of one or more springs 152 that apply compression to the stacked set of disks 150 for maintaining electrical contact during CR motor operation.

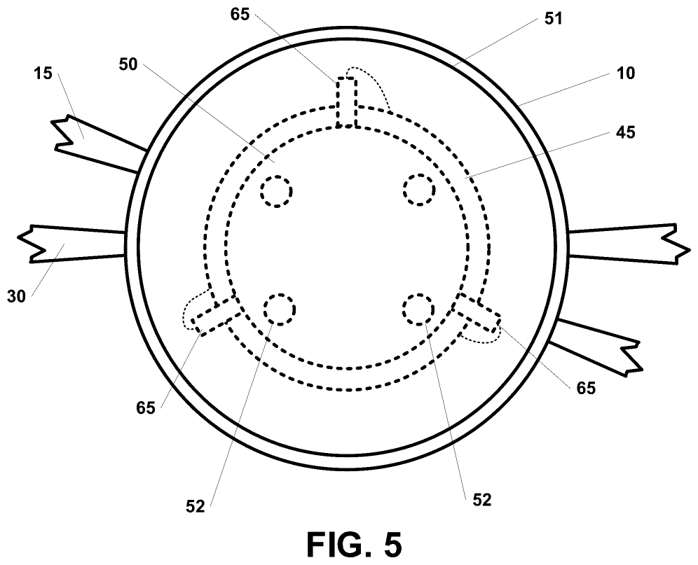

FIG. 5 illustrates, for the first CR motor embodiment 5, that a preferred configuration within the slip ring assemble for the exiting disk connections/wires 65 (leading to the field coils 14) is a symmetrical arrangement within the spindle housing 45. The symmetrical arrangement of the connections/wires 65 minimizes any harmful or energy wasting rotational vibrations.

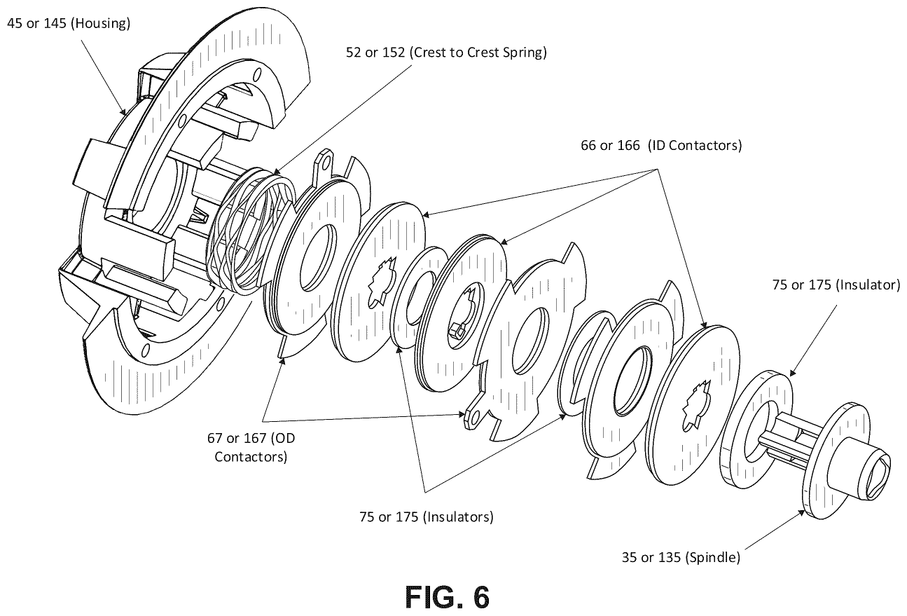

FIGS. 6 through 9 depict an alternative embodiment of the subject slip ring assembly. FIG. 6 shows the basic component of this embodiment of the slip ring assembly. The housing 45 or 145 (relative to the earlier presented versions) surrounds the various components of the slip ring assembly. The resilient means 52 or 152 in this embodiment is a crest to crest spring, which is equivalent to the individual springs shown earlier since its role is to compress the components during rotational operation. A series of three outside diameter contactors (OD contactors) 67 or 167 are shown (these are stationary and are utilized to connect to outside locations), along with three inside diameter contactors (ID contactors) 66 or 166 (these are rotating, during operation, and are utilized to connect to the CR motor). Appropriate insulators 75 or 175 are utilized to isolate each disk pairing.

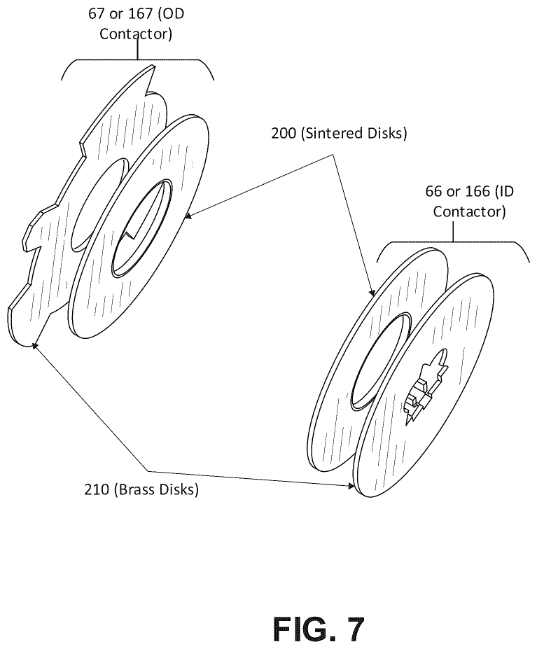

FIG. 7 shows that a single disk pair. The disk pair is comprised of an OD contactor 67 or 167, which consists of a brass disk 210 (copper, bronze, steel, or other equivalent material is also suitable) and a sintered disk 200, and an ID contactor 66 or 166, which also consists of a brass disk 210 (copper, bronze, steel, or other equivalent material is also suitable) and a sintered disk 200. To facilitate electrical contact, each brass disk 210 and sintered disk 200 are adhered to one another by soldering or similar fashion.

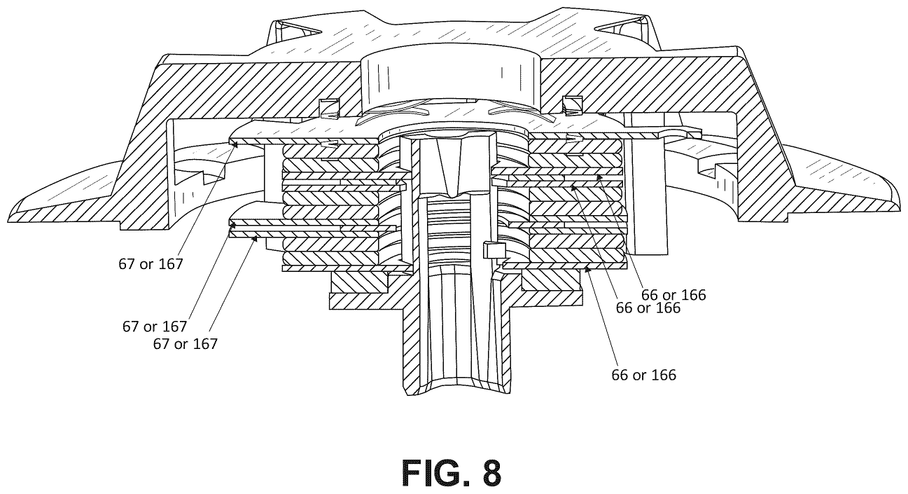

FIG. 8 shows the assembled slip ring assembly with OD contactors 67 or 167 and ID contactors 66 or 166 located within the stack of disks.

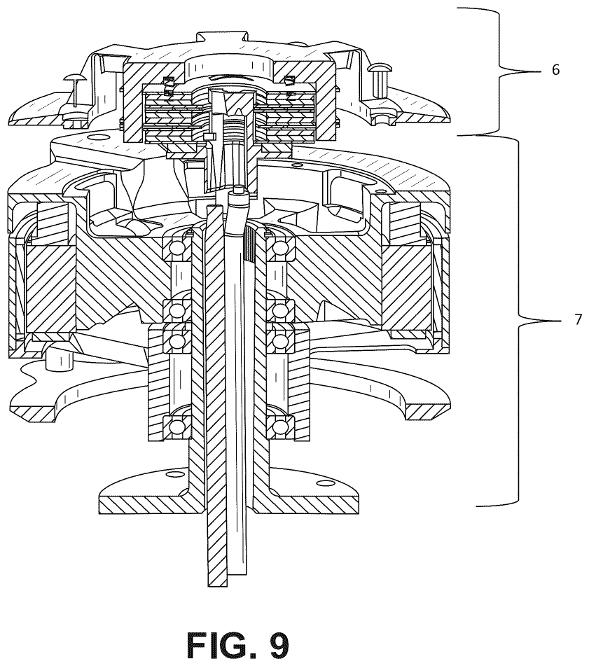

FIG. 9 shows the slip ring assembly 6 positioned over the CR motor components 7.

With horizontal flight and VTOL aircraft, the CR motor mount 40 and 140 frequently have apertures that are utilized to secure the subject CR motors 5 and 100 to a selected aircraft. One advantage of the subject CR differential motor assembly 5 and 100 is that they easily fit within the region a traditional/standard motor with propellers fits.

The onboard power supply/source is frequently a suitable battery or batteries. Additionally, a standard and easily purchased electronic speed controller (ESC) is employed to control the incoming electricity to actuate the field coil windings 14 in a pattern that creates the necessary magnetic repulsive forces to power rotation and to initiate and continue rotation.

Usually, an onboard controller with horizontal flight and VTOL aircraft is in remote communication with a ground controller by radio waves, infrared signals, or the equivalent.

The differential or first-to-second propeller-feed-back action of the subject invention is important in explaining the effectiveness or efficiency of the subject invention which has two internally differentially coupled propellers compared with a traditional/standard motor outfitted with only a single propeller. The set of blades on the first propeller encounters oncoming air and increases the velocity of the leaving air. The set of blades on the second propeller encounters the first propeller-accelerated air which causes the second rotational member to rotate faster, which in turn further accelerates the first rotational member and the internally differentially coupled two rotational members operate with a higher efficiency than a motor with only one propeller that provides no synergistic feed-back enhancement between rotational members, as is seen for the CR version.

A first embodiment of the subject technology includes a rotational slip ring assembly for transmitting electricity from a first location to a second location, comprising: at least one pair of electrically conductive disks with each disk having a central aperture that comprise: a first disk having an inner aperture edge and an outer perimeter edge and a second disk having an inner aperture edge and an outer perimeter edge; a first location electrical connection attached to the first disk's inner aperture edge; a second location electrical connection attached to the second disk's outer perimeter edge; and a spindle housing surrounding the pair of electrically conductive disks, wherein the spindle housing permits the pair of electrically conductive disks to rotate on one another.

A second embodiment of the subject technology comprises a rotational slip ring assembly for transmitting electricity from a first location to a second location, comprising: a set of paired lubricated sintered disks with each disk having a central aperture that are electrically conductive, wherein each pair comprises: a first disk having an inner aperture edge and an outer perimeter edge and a second disk having an inner aperture edge and an outer perimeter edge; a first location electrical connection attached to the first disk's inner aperture edge; a second location electrical connection attached to the second disk's outer perimeter edge; a spindle housing surrounding the set of paired electrically conductive disks, wherein the spindle housing permits the set of paired electrically conductive disks to rotate on one another; an electrically insulating disk with a central aperture positioned between each pair of the lubricated sintered disks; and compression springs held within the spindle housing that urge the set of paired electrically conductive disks and insulating disks together to maintain electrical contact within each paired electrically conductive disks during rotation of the set of paired electrically conductive disks.

A third embodiment of the subject technology comprises a rotational slip ring assembly wherein each second location electrical connection attached to each second disk's outer perimeter edge are symmetrically arranged about the set of paired disk's central apertures.

A fourth embodiment of the subject technology comprises an improved slip ring assembly that includes paired sets of electrically conductive disks with each pair separated by an insulating disk, wherein said improvement comprises: a set of paired disks with each disk having a central aperture that are electrically conductive, wherein each pair comprises: a first disk having an inner aperture edge and an outer perimeter edge and a second disk having an inner aperture edge and an outer perimeter edge; a first location electrical connection attached to said first disk's inner aperture edge; a second location electrical connection attached to said second disk's outer perimeter edge; a spindle housing surrounding said set of paired electrically conductive disks, wherein said spindle housing permits said set of paired electrically conductive disks to rotate on one another; an electrically insulating disk with a central aperture positioned between each pair of said disks; and compression springs held within said spindle housing that urge said set of paired electrically conductive disks and insulating disks together to maintain electrical contact within each said paired electrically conductive disks during rotation of said set of paired electrically conductive disks.

A fifth embodiment of the subject technology comprises an improved slip ring assembly wherein the set of paired disks contains at least one lubricated sintered disk. Additionally, the improved slip ring assembly may have the set of paired disks that are both lubricated sintered disks.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing group of elements, indicates that at least one of these group elements is present, which includes any possible combination of these listed elements as applicable.

References in this specification referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

As used herein, the terms “approximately”, “approximate”, “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A rotational slip ring assembly for transmitting electricity between a non-rotating environment and a rotating environment, comprising:
a. a hollow spindle about which sets of paired electrically conductive disks and electrically isolating disks between each paired electrically conductive disks rotate, wherein when in operation one disk in each said pair of electrically conductive disks is non-rotating and the other disk in each said electrically conductive pair is rotating and wherein said hollow spindle mounts above or into an associated rotating mechanical device;
b. a spindle housing positioned over sets of paired electrically conductive disks and electrically isolating disks, wherein said spindle housing permits each said set of paired electrically conductive disks to contact and rotate on one another;
c. said set of paired electrically conductive disks with each disk within each said set having a central aperture and each disk lubricated and electrically conductive, wherein each said pair of electrically conductive disks comprises:
i. a first non-rotating disk having an inner aperture edge and an outer perimeter edge, wherein said first non-rotating disk inner aperture edge slides over said hollow spindle and
ii. a second rotating disk having an inner aperture edge and an outer perimeter edge, wherein said second rotating disk inner aperture edge slides over said hollow spindle;
d. a first location electrical connection attached to each said first non-rotating disk's inner aperture edge, wherein incoming wires attach and transfer electricity to or from the non-rotating environment;
e. at least one second location electrical connection attached to each said second rotating disk's outer perimeter edge and for more than one, all are equally spaced about said central aperture with wires running to field coils and delivering electricity during rotational operation, wherein wires attach transfer electricity to or from the rotating environment;
f. an electrically insulating disk with a central aperture that slides over said hollow spindle positioned between each pair of said disks; and
g. a spring means is held within said spindle housing that urges said set of paired electrically conductive disks and insulating disks together to maintain electrical contact within each said paired electrically conductive disks during operational rotation of said sets of paired electrically conductive disks.

2. The slip ring assembly according to claim 1, wherein said set of paired disks contains at least one lubricated sintered disk.

3. The slip ring assembly according to claim 1, wherein said set of paired disks are both lubricated sintered disks.
